(19) United States
(12) Patent Application Publication
(10) Pub. No.: US 2008/0002855 A1
(43) Pub. Date: Jan. 3, 2008

(54) Recognizing An Unidentified Object Using Average Frame Color

(76) Inventors: Barinder Singh Rai, Surrey (CA); Eric Jeffrey, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/428,453

(22) Filed: Jul. 3, 2006

(51) Int. Cl. G06K 9/00

(52) U.S. Cl. 382/103; 382/162

(57) ABSTRACT

Methods, apparatus, systems and machine readable media are disclosed. In one embodiment, a method includes determining at least one parameter from substantially all of first digital image data of a first known object, and determining at least one parameter from substantially all of second digital image data of an unidentified object. In addition, the method includes identifying the unidentified object, at least in part, by comparing the at least one parameters for the first and second image data, wherein the at least one parameter is a measure of the central tendency of data.

### BACKGROUND

Exemplary applications of the claimed inventions relate generally to object recognition in computing and communication devices and systems.

Today, battery-powered hand-held computing and communication devices, such as mobile telephones, personal digital assistants, digital cameras, and digital music players are ubiquitous. Increasingly, these devices are equipped with a camera. It would be desirable to provide object recognition capability in these battery-powered, camera-equipped, portable computing and communication devices. There are a number of features that could be added to a camera-equipped portable device if the computer systems in such devices included the capability to recognize objects.

Techniques have been developed for object recognition using a computer system. The known techniques generally require numerous steps and calculations. Accordingly, the known techniques are computationally intensive. It is believed that up until now, in order to provide a computer system having object recognition capability, it has been necessary to employ a relatively powerful computer system, e.g., a main frame, work station, or powerful personal computer. Further, it is believed that up until now battery-powered, hand-held, multipurpose devices have not been considered adequate for the task of object recognition for the reason that they lack sufficient computing resources. In addition, even if a portable device were provided with sufficient computing resources, the importance of minimizing processing and memory requirements in order to minimize power consumption and maximize battery life makes the object recognition task impractical for such devices.

Many of the features that could be added to a camera-equipped portable device if the computer systems in such devices included the capability to recognize objects would likely be consumer oriented. As such, the object recognition scheme would likely not require the robustness of some of the known, but computationally intensive object recognition techniques developed for industrial use. Thus, a less computationally intensive, but effective object recognition technique for use in camera-equipped portable computing and communication devices would be useful.

### SUMMARY

In one embodiment, a method is disclosed. The method includes: (a) determining at least one parameter from substantially all of first digital image data of a first known object; (b) determining at least one parameter from substantially all of second digital image data of an unidentified object; and (c) identifying the unidentified object, at least in part, by comparing the at least one parameter for the first and second image data, wherein the at least one parameter is a measure of the central tendency of data.

In one embodiment, an apparatus is disclosed. The apparatus includes: (a) a memory having stored therein at least one parameter, the at least one parameter being determined from substantially all of first digital image data of a first known object; (b) and a processor, wherein the operations of the processor include: (i) determining at least one parameter from substantially all of second digital image data of an unidentified object; and (ii) identifying the unidentified object, at least in part, by comparing the at least one parameter for the first and second image data, wherein the at least one parameter is a measure of the central tendency of data.

In one embodiment, a machine-readable medium is disclosed. The machine-readable medium has stored thereon data representing sequences of instructions that, when executed by a processor, cause the processor to perform operations comprising: (a) determining at least one parameter from substantially all of first digital image data of a first known object; (b) determining at least one parameter from substantially all of second digital image data of an unidentified object; and (c) identifying the unidentified object, at least in part, by comparing the at least one parameters for the first and second image data, wherein the at least one parameter is a measure of the central tendency of data.

In one embodiment, a computer system is disclosed. The computer system includes: (a) a memory having stored therein at least one parameter, the at least one parameter being determined from substantially all of first digital image data of a first known object; (b) and a processor, wherein the operations of the processor include: (i) determining at least one parameter from substantially all of second digital image data of an unidentified object; and (ii) identifying the unidentified object, at least in part, by comparing the at least one parameters for the first and second image data, wherein the at least one parameter is a measure of the central tendency of data.

### BRIEF DESCRIPTION OF DRAWINGS

FIG. 1 illustrates an example system.

FIG. 2 is a flow chart illustrating an example process.

FIG. 3 illustrates an exemplary application.

FIG. 4 illustrates another exemplary application.

FIG. 5 illustrates an example system.

FIG. 6 illustrates the object recognition unit of FIG. 5 in more detail.

### DETAILED DESCRIPTION

The claimed invention is described by way of exemplary embodiments, but not limitations, illustrated in the accompanying drawings, which are incorporated herein and constitute a part of this description. The same reference numbers may be used in different drawings and the description to identify the same or similar elements. In the following description, for purposes of explanation and not limitation, specific details may be set forth as exemplary structures, architectures, interfaces, techniques, and the like in order to provide a thorough understanding of various aspects of the claimed inventions. However, it will be apparent to those skilled in the art, having the benefit of the present description, that the claimed invention may be practiced in other examples that depart from these details. Moreover, those skilled in the art will appreciate that the claimed invention may be practiced with only some or with all of the aspects described herein. In addition, in certain instances, descriptions of well known devices, circuits, and methods may be omitted so as not to obscure the description of the examples with unnecessary detail.

Aspects of the disclosed embodiments may be described in terms of operations performed by a computer system, using terms such as data, flags, bits, values, characters, strings, numbers and the like, consistent with the manner commonly employed by those skilled in the art to convey the substance of their work to others skilled in the art. As understood by those skilled in the art, these quantities take the form of electrical, magnetic, or optical signals capable of being stored, transferred, combined, and otherwise manipulated through mechanical and electrical components of the computer system.

In addition, aspects of the disclosed embodiments may be described as multiple discrete steps being performed in a particular sequence. It should be understood, however, that the particular sequence in which the steps are presented is for the sole purpose of aiding the reader in understanding the disclosed embodiments, and the order of description should not be construed to imply that such steps must necessarily be performed in the order of their presentation.

The term “pixel” includes a point sample of an image, as well as the small discrete elements on a display screen that together form a digital image. The phrase “digital image data” includes the numeric value or values that define the attributes, such brightness and color, of at least one pixel. For convenience of explanation and in accordance with the use of the term in the art, the term pixel may sometime be used herein to refer to digital image data. The term “frame” includes an array of pixels that forms all or a portion of a digital image.

The phrase “machine-readable medium” includes any data storage device that can store data that can be thereafter read by a computer system. Examples of machine-readable medium include flash memory, hard drives, network attached storage, ROM, RAM, CDs, magnetic tapes, and other optical and non-optical data storage devices. A machine-readable medium can also be distributed over a network-coupled computer system so that the machine readable code is stored and executed in a distributed fashion.

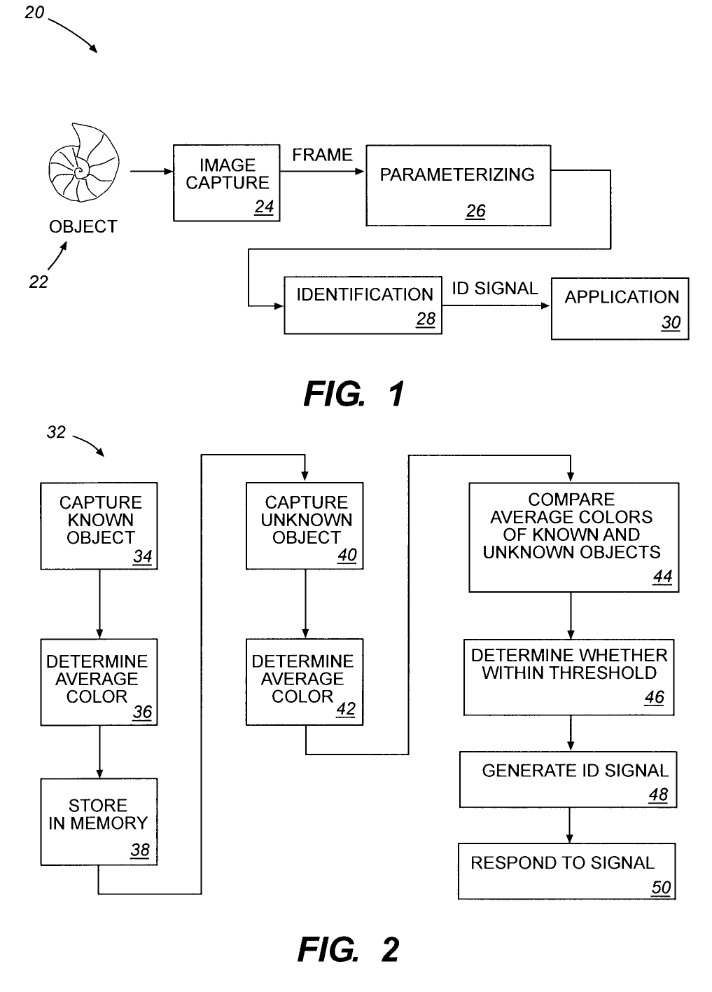

FIG. 1 illustrates an example system 100. Exemplary implementations of the system 100 may include a mobile telephone, a digital camera, a personal digital assistant, a mobile computer, and other portable, battery-powered electronics devices. Other exemplary implementations of the system 100 may include an electronic device mounted in a vehicle or near the entrance to a building. In other examples, the system 100 is implemented in a general-purpose computer or in an electrical system. It should be appreciated, however, that the claimed invention is not limited to these exemplary implementations. Moreover, although system 100 may be embodied in a single device, in some implementations certain components of system 100 may be remote or physically separated from other components of system 100. Further, although system 100 is illustrated as including discrete components, these components may be implemented in hardware, software, firmware, or a combination of one or more of these elements. When implemented in hardware, some components of system 100 may be combined in an integrated circuit (“IC”) or device.

Referring to FIG. 1, it can be seen that a block diagram of the system 100 includes an object 22 and an image capture 24 portion. The image capture portion 24 captures and generates a digitized image of the object 22. The system 100 also includes an parameterizing portion 26, an identification portion 28, and an application 30. The parameterizing portion 26 receives a frame of digital image data from the image capture portion 24 and determines one or more parameters that correspond to an average or other measure of central tendency of the set of image data. The one or more parameters (referred to herein for convenience as an “average value parameter”) are provided to the identification portion 28, which attempts to identify the object. As described below, the identification portion 28 produces an identification signal that indicates that the object 22 has or has not been identified.

The object 22 may be anything that is observable. The object 22 may be a physical item, such as a shell, a face, the palm of a hand, a tattoo, the cover of a book, a business card, or a solid-colored card. The application 108 may be any application that may use the identification signal, including personal, business, education, and entertainment applications.

The image capture portion 24 generates a digitized image of the object 22. In particular, the image capture portion 24 generates a frame of image data. Any method or device may be employed. The image capture portion 24 may include an image sensor, such as a charge-coupled-device (“CCD”) sensor or a complementary-metal-oxide-semiconductor (“CMOS”) sensor. The image sensor may be capable of outputting frames in several different resolutions. The image sensor may be disposed on a discrete unit separate from the image capture portion 24 or may be integrated in the image capture portion 24. Further, the image sensor may be responsive to only light of a particular region of a spectrum, e.g., visible light, infrared radiation, etc, or it may be responsive to more than one spectral region. In addition, the image capture portion 24 may be adapted to generate still images or video.

The digital image data generated by the image capture portion 24 may be of a type for defining any type of image, e.g., black and white, gray scale, or color. In addition, the digital image data may be in any of a variety of different forms and formats. For example, the digital image data may be in the RGB, CMYK, YIQ, YUV, YPrPb, YCrCB, HSV, HSL, or other color space. Further, the digital image data may be in a chroma subsampled format, such as 4:2:2, 4:1:1, 4:2:0, 4:2:1, or other format. Additionally, the digital image data may correspond to a full or reduced resolution image. Moreover, the digital image data may be represented by any number of bits per pixel, e.g., 1, 2, 4, 8, 12, 15, 16, 24, and 32. In addition, in some embodiments, the image data may be sampled or filtered. As one example, pixels having luma or color values generally associated with the background portion of an image of an object may be filtered. As another example, pixels having luma or color values generally associated with the type of object normally identified are sampled. As a specific example, pixels having luma or color values generally associated with skin tones may be sampled where the type of object normally identified is a human face. As yet another example of sampling, pixels corresponding to locations in the fours corners of a frame and corresponding to fewer than ten percent of the total pixels in the frame may be excluded from the set of image data for the frame.

The parameterizing portion 26 determines an average value parameter for the frame of digital image data provided by the image capture portion 24. The identification portion 28 either identifies or does not identify the object, and produces an identification signal. In the former case, the identification portion 28 generally produces an identification signal indicating that the object is identified. In the later case, the identification portion 28 produces an identification signal indicating that the object is not identified. Thus, the identification signal may be a simple binary indication. In one embodiment, several identification signals are provided. For example, the signal may indicate that an unidentified object is a particular object selected from a set of two or more known objects. In addition, the identification signal may be internal, e.g., changing certain state data, or external, e.g., an audible sound, a visual indication, or both internal and external.

FIG. 2 is a flow chart illustrating a process 32 of recognizing an unidentified object. Although process 32 may be described with regard to system 20 for ease of explanation, the claimed invention is not limited in this regard. Processing may begin in step 34 with the image capture portion 24 capturing an image of a known object 22 and generating digital image data in the form of a frame of pixels. In one embodiment, the digital image data may be provided by a device or unit other than the image capture portion 24. For example, the digital image data may be transmitted to the parameterizing portion 28 from a system or device remote to the system 20.

Processing may continue with the parameterizing portion 26 determining an average value parameter for the digital image data for a frame of pixels, as indicated at step 36. One way to determine an average value parameter may be to compute the arithmetic mean of the digital image data, e.g., the sum of all pixel values divided by the number of pixels in the frame. In other embodiments, the average value parameter may be other measures of the central tendency of the set of digital image data, such as the median (the middle value that separates the higher half from the lower half of the data set) or the mode (the most frequent value in the data set) of the data. In still other embodiments, the average value parameter is a weighted mean (an arithmetic mean that incorporates weighting to certain data elements) or truncated (the arithmetic mean of data values after a certain number or proportion of the highest and lowers data values have been discarded) mean. As one example, the parameterizing portion 26 may determine an average value parameter by under-weighting pixels having luma or color values generally associated with the background portion of an image and over-weighting pixels having luma or color values generally associated with the type of object normally identified. For instance, YUV pixels with low luma values may be under-weighted while YUV pixels with high luma values may be over-weighted. As another example, YUV pixels with very low luma values may be excluded from the average.

Moreover, in one embodiment, the parameterizing portion 26 filters the frame of image data prior to determining an average value parameter for frame of image data at step 36. Any type of filtering may be employed. For example, a band pass filter may be applied so that the average value parameter is determined only from pixels falling in a particular luma or color range.

In one embodiment, the average value parameter is determined using the numeric values defining gray scale pixels. In another embodiment, the average value parameter is determined using the numeric values defining color pixels, which may include one or more components. In other embodiments, the average value parameter is determined using less than all of the components used to define color pixels. For example, where color pixels are defined by a luma (Y) component and two chroma components (Cr, Cb), the average value parameter may be calculated using only the chroma channels.

Regardless of whether the average value parameter is an arithmetic mean, a median, mode, weighted mean, truncated mean, or other measure of the central tendency of a set of data known in the art, it should be appreciated that it is contemplated that insubstantial portions of the data may be discarded in some embodiments. Insubstantial portions of data may be discarded for any reason. Data may be discarded, as mentioned above with regard to pixels located in the four corners of a frame, because it is not of significant use in identifying an unidentified object. Data also may be discarded because processing is simplified. Depending on the type of object being identified and the degree of accuracy desired for the identification, 0.1, 1, 5, 10 or a higher percent of the pixels may be excluded from the calculation of the average value parameter with reliable identification of the object 22 still being possible. As one example, every 10th pixel when proceeding in raster sequence may be excluded. Where it is possible to exclude a particular proportion of the pixels and still obtain reasonably reliable object identification, then the portion of pixels that are used in computing the average value parameter may be considered substantially all of the pixels in the frame.

After the parameterizing portion 26 determines at least one average value parameter for the known object 22, it provides the parameter to the identification portion 28. Processing may continue with the identification portion 28 storing the parameter associated with the known object in a memory, as indicated at step 38.

In one embodiment, the steps 34-38 may be repeated in order to store average value parameters for two or more known objects. For example, average value parameters for a face and a card may be stored.

Further, more than one average value parameter may stored for the same known object. As one example, the average value parameter for the known object 22 may be determined for a particular face when viewed under different lighting conditions, when viewed from distinct angles, or when viewed as filling smaller and larger portions of the frame. In addition, as mentioned the average value parameter may be determined in a variety of ways. In another embodiment, the parameterizing portion 26 may determine more than one average value parameter for the known object 22 using different methods, e.g., a weighted average and a median value of the data set.

Processing may continue in step 40 with the image capture portion 24 capturing an image of an unidentified object 22 and generating digital image data in the form of a frame of pixels. The parameterizing portion 26 in step 40 may then determine an average value parameter for the unidentified object 22 and provide the parameter to the identification portion 28.

With respect to the steps 40 and 42, these steps are similar to the steps 34 and 36 just described. The image capture portion 24 may capture an image of an unidentified object in the manner described above for a known object. Further, the parameterizing portion 26 may determine the average value parameter for an unidentified object in the manner described above for a known object. For this reason, it will be appreciated that description of steps 34 and 36 applies equally to the steps 40 and 42. That is, the average value parameter for an unidentified object may be any measure of central tendency described above; the image data for an unidentified object may be filtered prior to determining the average value parameter; insubstantial portions of the data for an unidentified object may be discarded; two or more average value parameters may be determined for an unidentified object; and so on. It will be appreciated that the full description in not repeated for brevity.

Processing may continue in step 44 with the identification portion 28 comparing average value parameter of the unidentified object with the average value parameter of a known object. In one embodiment, the comparing is performed by subtracting. In one embodiment, if the average value parameters for the known and unidentified objects are equal, then the identification portion 28 provides an indication, as denoted at step 48, that the unidentified object has been identified as the particular known object. For an indication of identification, the respective average value parameters may be exactly equal or may be within a predetermined threshold, as indicated by step 46. In another embodiment, if the average value parameters for the known and unidentified objects are within the particular range or threshold, then the unidentified object may be deemed identified. For example, assume that the average value parameter for the known object is 170, that the average value parameter for the unknown object is 179, and that the particular range is plus or minus 10. In this case, the unidentified object would be deemed identified because the average value parameter for the unknown object falls within the range.

In one embodiment, the identification portion 28 compares the average value parameter of the unidentified object with the average value parameters of two or more known objects. In addition, in the event that the unidentified object is identified as being one of the two or more known objects, the identification portion 28 may, at step 48, provide an indication as to which object it is.

In response to the indication that the object has or has not been identified, application 30 may take a particular action or invoke a particular process. In some implementations, an indication that the object has been identified causes the application 30 to permit access or use of a machine or device.

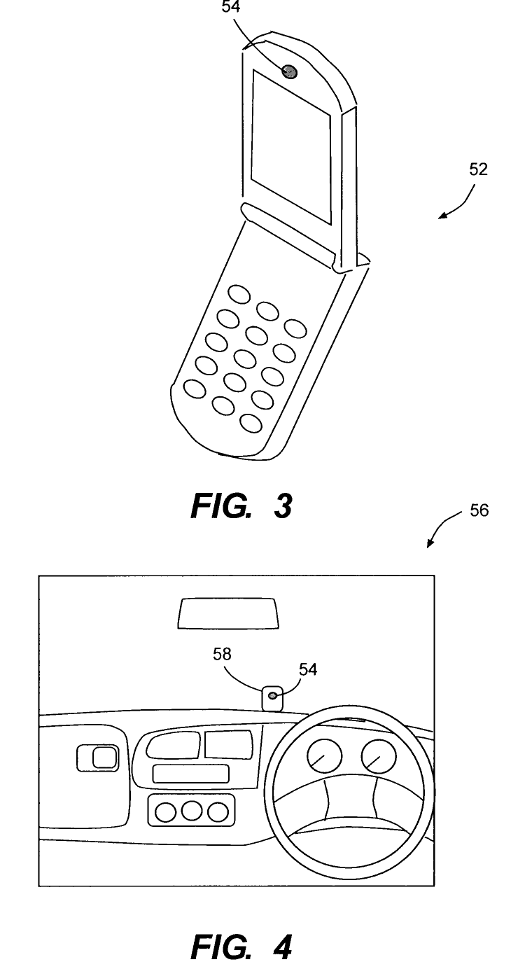

FIG. 3 illustrates an exemplary implementation of the system 100. A mobile telephone 52 equipped with a camera 54 is shown. All or portions of the system 100 reside within circuitry, software, firmware, or a combination of one or more of these elements disposed within the telephone 52. The primary source of power for the telephone 52 is an internal battery. In this implementation, the application 30 includes a security feature that controls whether the telephone 52 can be used. A digital image of a known card of a particular color, e.g., red, is captured, an average value parameter for the resulting digital image data is determined, and stored in a memory in the telephone. Subsequently, a digital image of an unidentified card of another color, e.g., pink, is captured, an average value parameter for the resulting digital image data is determined, the average value parameters for the known red card and the unidentified pink card are compared, and an indication that the unidentified card has not been identified causes the application 30 to stay in a state in which the telephone 52 is not able to be used. Alternately, a unidentified card that is red in color is captured, causing the application to enable the telephone for use.

FIG. 4 illustrates another exemplary implementation of the system 100. An interior portion of an automobile 56 is shown. Portions of the system 100 reside within circuitry, software, firmware, or a combination of one or more of these elements disposed within a dash-mounted unit 58, which includes a camera 54. In this implementation, the application 30 again includes a security feature that controls whether the automobile 56 can be used. However, in this implementation, the application 30 resides in circuitry, software, or firmware disposed within the automobile 56. The dash-mounted unit 58 and the application 30 are provided with transceivers or similar devices in order to provide a communication capability between the unit 58 and the application. The particular manner in which the unit 58 and the application 30 communicate is not critical. They may communicate by wire, wirelessly, or optically. One of ordinary skill in the art will known that there are many ways in which the unit 58 and the application 30 may be communicatively coupled. Digital images of two known faces, e.g., the face of a very-dark-skinned and dark haired male and a less-dark-skinned and dark haired female, are captured, average value parameters for the resulting frames of digital image data are determined, and stored in a memory in the unit 58. Subsequently, a digital image of an unidentified face is captured. An average value parameter for the resulting digital image data is determined, the average value parameters for the two known faces and the unidentified face are compared. An indication may be provided to the application 30 that the unidentified face has been identified. Optionally, an indication may be provided that the unidentified face has been identified as the face of the male. In response to the indication, the application 30 enables access to the automobile, permitting the driver to start the engine. Moreover, where the unidentified face is identified as the face of a known face, the application 30 may configure the automobile with personal settings associated with the known face. Personal settings may include, for example, the maximum speed at with the automobile can be driven, the maximum distance from a given point that the automobile can be driven, the seat height, mirror adjustments, and other settings. In one embodiment, the application 30 may be used for security purposes. For example, an image of a pale-complected, light haired unidentified face may be captured. An average value parameter for the resulting digital image data is determined. Again, the average value parameters for the two known faces and the unidentified face are compared. This time, however, an indication is provided to the application 30 that the unidentified face has not been identified. In response to the indication, the application 30 disables access to the automobile. In one alternative implementation, the unit 58 is the mobile telephone 52 and a dash-mounted base (not shown) for holding the telephone. In yet another embodiment, the unit 58 includes a light source, such as a flash attachment, for providing standardized illumination when capturing digital image data of a known or unidentified face (or other object).

In the exemplary implementation shown in FIG. 4, certain system 100 elements, such as the camera, are disposed within a dash-mounted unit 58. In other exemplary implementations, the unit 58 may be mounted on or integrated with the rearview mirror, the sun visor, the steering wheel, or embedded in the dash board.

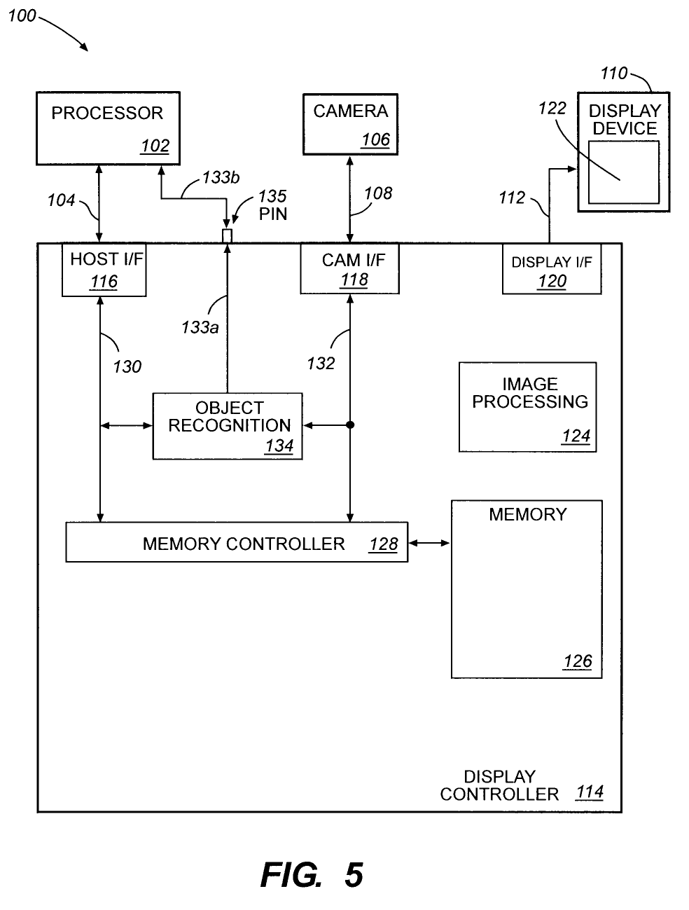

FIG. 5 illustrates a hardware view of one embodiment that includes a computer system 100. The computer system 100 may be a general or special purpose computer. In addition, the computer system 100 may be a standalone system or may be embedded in another machine or system. In one embodiment, the computer system 100 is a portable digital appliance that is primarily powered by a battery (not shown). Although system 100 may be embodied in a single device, in some implementations certain components of system 100 may be remote or physically separated from other components of system 100. Further, although system 100 is illustrated as including discrete components, these components may be implemented in hardware, software, firmware, or a combination of one or more of these elements. When implemented in hardware, some components of system 100 may be combined in a particular IC or device.

As shown, for the illustrated embodiment, computer system 100 includes a processor 102, a processor bus 104, a camera 106, a camera bus 108, a display device 110, and a display device bus 112. The processor 102, camera 104, and display device 110 are coupled via their respective buses to a display controller 114. The display controller 114 includes a host interface 116 that interfaces with the processor bus 104, a camera interface 118 that interfaces with the camera bus 108, and a display interface 120 that interfaces with the display bus 112. These elements of the system 100 perform conventional functions known in the art.

The processor 102 may be a microprocessor or a digital signal processor, or any other type of device adapted for controlling digital circuits.

The camera 104 generates a digitized images of an object, using any known method or device. The camera 104 may include a CCD or CMOS image sensor and may be capable of outputting frames in several different resolutions. The camera 104 generates digital image data. Like the image capture portion 24, described above, the digital image data generated by the camera 104 may be of any type, in any form or format, may be chroma subsampled, may be at full or reduced resolution, and may be represented by any number of bits per pixel. The camera 104 may be responsive to visible light or to another range of frequencies, such as infra-red.

The display device 110 includes, in one embodiment, a display screen 122. The display device 110 may be any device capable of rendering image data, including, but not limited to LCD, CRT, plasma, and OLED display devices, as well as hard copy rendering devices, such as laser and inkjet printers.

The display controller 114 may be a discrete IC, separate from the remaining elements of the system, that is, it may be remote from the processor, camera, and display device. In other embodiments, the display controller 114 may be embedded within a system or device. In one embodiment, the display controller 114 performs a number of image processing operations may be performed on data provided by an image data source, such as the processor or the camera. Such image processing operations may be performed by units included in an image processing block indicated generally as 124 in FIG. 5. The image processing block 124 may include, for example, a CODEC for compressing and decompressing image data. In one embodiment, the display controller 114 includes a memory 126 for storing data. In other embodiments, however, the memory 126 may be remote from the display controller 114. The display controller 114 may include a memory controller 128 for mediating access to the memory 126. The display controller 114, in one embodiment, includes an first internal bus 130 and a second internal bus 132. The first internal bus 130 couples the host interface 116 with the memory controller 128 and other internal units of the display controller 114. The second internal bus 132 couples the camera interface 118 with the memory controller 128 and other internal units of the display controller 114.

In one embodiment, the display controller 114 includes an object recognition unit 134. The object recognition unit 134 is communicatively coupled with the processor 102 via the first internal bus 130 and with the camera 106 via the second internal bus 132. The object recognition unit 134 may also use the internal buses 130, 132 to communicate with internal units of the display controller 114. For example, the object recognition unit 134 may read or store values in internal registers using the internal buses. In addition, the object recognition unit 134 may communicate with the memory via either internal bus. Furthermore, the object recognition unit 134 may communicate directly with an external device via a signal line or lines 133a coupled with a pin 135. In one embodiment, the pin 135 is coupled with the processor 102 and the object recognition unit 134 communicates directly with the processor via line 133a, pin 135, and a line 133b.

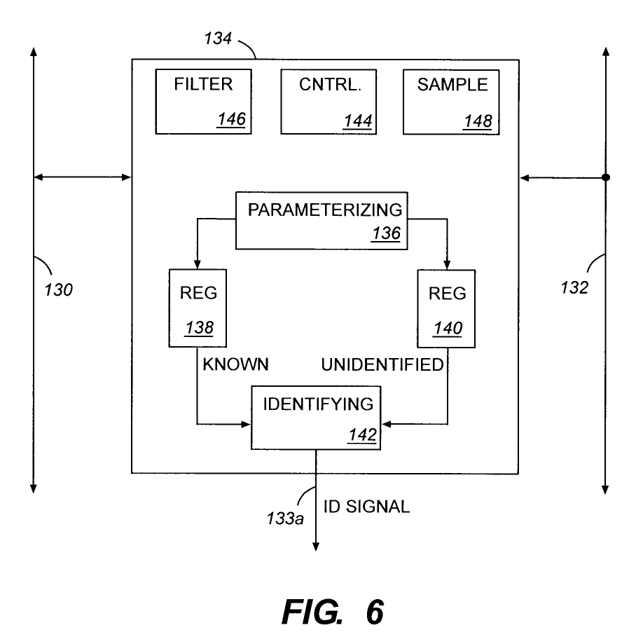

FIG. 6 illustrates the object recognition unit of FIG. 5 in more detail. The object recognition unit 134 includes a parameterizing unit 136 for determining at least one average value parameter from a frame of digital image data provided by, in one embodiment, the camera 106. If the frame of image data is for a known object, the parameterizing unit 136 may store an average value parameter in a first register 138. If the frame of image data is for an unidentified object, parameterizing unit 136 may store an average value parameter in a second register 140. The object recognition unit 134 also includes an identification unit 142.

The identification unit 142 either identifies or does not identify an unidentified object, and produces an identification signal. The object recognition unit 134 makes its determination by comparing the average value parameter of the unidentified object with the average value parameter of a known object. In one embodiment, the comparing is performed by subtracting. In one embodiment, if the average value parameters for the known and unidentified objects are equal, then the identification unit 142 provides an indication signal indicating that the unidentified object has been identified as a particular known object. The respective average value parameters may be exactly equal or may be within a predetermined threshold or range. In various exemplary embodiments, the predetermined range is plus or minus 1, 2, 5, 8, 10, 12, and 15 percent. Other predetermined ranges may be employed. In one embodiment, the identification unit 142 compares the average value parameter of the unidentified object stored in register 140 with two or more average value parameters stored in register 138. The two or more average value parameters stored in register 138 may correspond to two or more known objects or to a single object captured under different lighting conditions. In addition, in the event that the unidentified object is identified as being one of the two or more known objects, the identification unit 142 may provide an indication as to which object it is.

The indication signal may be provided to the processor via the first internal bus 130. Alternatively, the indication signal may be provided to the processor or other external device via the pin 135. In yet other embodiments, the indication signal may be stored in a register (not shown) and provided to the processor via periodic polling of the register by the processor.

The object recognition unit 134 also includes a control unit 144, a filtering unit 146, and a sampling unit 148. The control unit 144 controls the overall operation of the object recognition unit 134. The filtering unit 146 may be employed for optionally filtering a frame of image data prior to determining an average value parameter for the frame. Any type of filtering may be employed. The sampling unit 148 may be employed for optionally sampling pixels in a frame so that some pixels are excluded from the set of image data used in determining an average value parameter for the frame. Any type of sampling may be employed.

The parameterizing unit 136 determines one or more average value parameters that correspond to an average or other measure of central tendency of a set of image data. The parameterizing unit 136 may determine an average value parameter by computing the arithmetic mean, median, mode, weighted mean, or truncated mean of a set of image data. In some embodiments, the parameterizing unit 136 determines the average value parameter after the set of image data has been filtered or sampled.

Although embodiments have been described principally in conjunction with battery-powered computing and communication devices, it should be appreciated that the claimed invention is as applicable, if not more applicable, when used with other computing and communication systems, such as a main frame, work station, or personal computer.

In general, those skilled in the art will recognize that the claimed inventions are not limited by the details described, in particular, the claimed inventions are not limited to the exemplary applications, instead, the claimed inventions can be practiced with modifications and alterations within the spirit and scope of the appended claims. The description is thus to be regarded as illustrative instead of restrictive on the claimed inventions.

What is claimed is:

1. A method comprising:
determining at least one parameter from substantially all of first digital image data of a first known object;
determining at least one parameter from substantially all of second digital image data of an unidentified object; and
identifying the unidentified object, at least in part, by comparing the at least one parameter for the first image data with the at least one parameter for the second image data, wherein the at least one parameter is a measure of the central tendency of data.

2. The method of claim 1, wherein identifying the unidentified object further comprises rejecting the first known object as the identity of the unidentified object if the parameters for the first and second image data are not within a predetermined range of one another.

3. The method of claim 1, wherein at least ninety percent of the first image data is used in determining the at least one parameter for the first image data.

4. The method of claim 1, further comprising capturing the first and second digital image data.

5. The method of claim 1, further comprising filtering the first image data before determining the at least one parameter from substantially all of the first digital image data, and filtering the second image data before determining the at least one parameter from substantially all of the second digital image data.

6. The method of claim 1, wherein determining the at least one parameter for the first and second image data comprises determining an arithmetic mean.

7. The method of claim 1, wherein determining the at least one parameter for the first and second image data comprises determining a mode.

8. The method of claim 1, wherein determining the at least one parameter for the first and second image data comprises determining a median.

9. The method of claim 1, further comprising:
determining at least one parameter from substantially all of third digital image data representing a second known object; and
identifying the unidentified object, at least in part, further includes comparing the at least one parameters for the third image data with the at least one parameter for second image data.

10. The method of claim 1, further comprising generating an output response in accordance with the result of identifying the unidentified object.

11. An apparatus comprising:
a memory having stored therein at least one parameter, the at least one parameter being determined from substantially all of first digital image data of a first known object; and
a processor, wherein the operations of the processor include:
determining at least one parameter from substantially all of second digital image data of an unidentified object; and
identifying the unidentified object, at least in part, by comparing the at least one parameter for the first image data with the at least one parameter for the second image data, wherein the at least one parameter is a measure of the central tendency of data.

12. The apparatus of claim 11, wherein the operation of the processor identifying the unidentified object comprises rejecting the first known object as the identity of the unidentified object if the parameters for the first and second image data are not within a particular range of one another.

13. The apparatus of claim 11, wherein the operation of the processor determining at least one parameter from substantially all of second digital image data of an unidentified object comprises determining the at least one parameter from at least ninety percent of the second image data.

14. The apparatus of claim 11, wherein the apparatus further comprises an image capturing device to capture a digital image of an object.

15. The apparatus of claim 11, wherein the apparatus further comprises an image filtering unit to filter a digital image of an object.

16. The apparatus of claim 11, wherein the operation of the processor determining at least one parameter from substantially all of second digital image data of an unidentified object comprises determining a mean.

17. The apparatus of claim 11, wherein the operation of the processor determining at least one parameter from substantially all of second digital image data of an unidentified object comprises determining a weighted mean.

18. The apparatus of claim 11, wherein the operation of the processor determining at least one parameter from substantially all of second digital image data of an unidentified object comprises determining a truncated mean.

19. A machine-readable medium having stored thereon data representing sequences of instructions that, when executed by a processor, cause the processor to perform operations comprising:
determining at least one parameter from substantially all of first digital image data of a first known object;
determining at least one parameter from substantially all of second digital image data of an unidentified object; and
identifying the unidentified object, at least in part, by comparing the at least one parameter for the first image data with the at least one parameter for the second image data, wherein the at least one parameter is a measure of the central tendency of data.
